(19) United States
(12) Patent Application Publication
(10) Pub. No.: US 2024/0382946 A1
(43) Pub. Date: Nov. 21, 2024

(54) FLUID TRANSFER DEVICE AND ASSOCIATED SYSTEM

(71) Applicant: THERMO FISHER SCIENTIFIC INC., Carlsbad, CA (US)

(72) Inventors: Ken S. CHAE, Encinitas, CA (US); Mikko Antero MAKINEN, Santa Clara, CA (US)

(21) Appl. No.: 18/787,210

(22) Filed: Jul. 29, 2024

Related U.S. Application Data
(63) Continuation of application No. PCT/US2023/013361, filed on Feb. 17, 2023.
(60) Provisional application No. 63/422,834, filed on Nov. 4, 2022.
(60) Provisional application No. 63/311,912, filed on Feb. 18, 2022.

(51) Int. Cl. B01L 3/02

(52) U.S. Cl. CPC B01L 3/021; B01L 2200/026; B01L 2200/0605; B01L 2200/0689; B01L 2300/042; B01L 2300/0832; B01L 2300/123; B01L 2400/0481

(57) ABSTRACT

A fluid transfer device that aspirates and dispenses fluid without a user needing to directly actuate the fluid transfer device by being actuated for aspiration when inserted into a device such as a vial or for dispensing when inserted into a receiving device such as a cassette. In embodiments, the cassette is designed as part of a system with the fluid transfer device which securely attaches to the cassette when dispensing a fluid sample.

### CROSS-REFERENCE TO RELATED APPLICATIONS

This application is a continuation of PCT application number PCT/US2023/013361, filed Feb. 17, 2023. PCT/US2023/013361 claims benefit of U.S. Provisional Application No. 63/422,834, filed Nov. 4, 2022, and benefit of U.S. Provisional Application No. 63/311,912, filed Feb. 18, 2022. All applications referenced in this section are incorporated herein by reference, each in its entirety.

### TECHNICAL FIELD

The present disclosure relates generally to a fluid transfer device for use in aspirating and dispensing a fluid sample alone or in combination with a receiving device.

### BACKGROUND ART

The transfer of fluids, such as liquids, from one location to another is essential in laboratory analytical work. Transfer devices, such as pipettes and micro pipettes have been developed for this type of work.

### SUMMARY OF INVENTION

Conventional flexible poly pipettes used for fluid transfer suffer from several drawbacks, especially when they are used in biological testing for detecting infectious pathogens. First, conventional flexible poly pipettes do not have a metering mechanism, resulting in transferred fluid, such as liquid, overloading or underloading the testing devices or testing instruments. Second, conventional pipettes are generally operated by direct contact between the hand and/or glove of the user and the pipette, which can potentially cause sample contamination. Additionally, conventional pipettes do not provide a safe disposal solution after they come in contact with hazardous materials such as infectious pathogens.

Overall, while pipette systems for fluid transferring exist, the need for improvements in this field persists in light of at least the aforementioned drawbacks for conventional flexible poly pipette systems.

Embodiments of the present disclosure provide a fluid transfer device that aspirates and dispenses fluid without a user needing to directly actuate the fluid transfer device. Instead, the fluid transfer device is actuated by inserting the fluid transfer device into a vial or a receiving device (also referred to herein as a cassette), where there is an opening with a dimension of the correct size to engage with and actuate the fluid transfer device. In embodiments, the fluid transfer device is equipped with an overflow that ensures a fixed amount of liquid is consistently aspirated and dispensed.

In embodiments, the fluid transfer device comprises an actuating mechanism that comprises a housing, a first actuator member connected to the lower portion of the housing at a first actuator hinge located at a first end, a second actuator member connected to the lower portion of the housing at a second actuator hinge located at a second end, the first actuator hinge being located at the opposing end of the housing from the second actuator hinge, a squeeze bulb located within the housing and a pipette tube coupled to the squeeze bulb. In embodiments, the squeeze bulb is elliptical in shape to provide a slower controlled operation of the fluid transfer device. In embodiments, the pipette tube is coupled to the squeeze bulb through an overflow channel at a location above the bottom surface of the squeeze bulb such that any excess liquid over an amount determined by the volume of the pipette falls into the bottom of the squeeze bulb which functions as an excess liquid reservoir. In embodiments, the excess liquid reservoir is not part of the squeeze bulb but is in fluid connection with the squeeze bulb. An air gap between the excess liquid reservoir and pipette tube prevents the excess liquid from being dispensed through the pipette tube. In embodiments, the first hinge and second actuator hinge are located on opposing ends of the bottom of the housing. The portion of the pipette tube located in the housing is configured such that it does not impede the function of the first and second actuator members.

The first actuator member has a first inner wall facing the housing and a first outer wall facing away from the housing. Similarly, the second actuator member has a second inner wall facing the housing and a second outer wall facing away from the housing.

In embodiments, a portion of the first outer wall and the second outer wall are curved concavely, with the curves each terminating at a vertex forming a first nub on the first outer wall and a second nub on the second outer wall configured to function as a latch when the fluid transfer device is used in combination with a cassette. In embodiments where manual aspiration and dispensing of a fluid sample is required, physical force can be applied by a user onto the first and second nubs to aspirate and dispense a sample.

In embodiments, both the first inner wall and second inner wall are curved concavely. In embodiments, the first inner wall and second inner wall are configured such that the first inner wall and second inner wall align in a longitudinal direction generally parallel to the squeeze bulb when in the fully actuated state. The first actuator member and second actuator member slidably engage with the housing and compress the squeeze bulb by pivoting the first inner wall at the first actuator hinge and pivoting the second inner wall at the second actuator hinge into the housing. In embodiments, the curvature of the first and second inner walls of the first and second actuator members aids in compression of the squeeze bulb. In an alternative embodiment, where the portion of the first and second inner walls align in a longitudinal direction generally parallel to the squeeze bulb when in the fully actuated state, the increased contact area of the first and second inner walls aids in the compression of the squeeze bulb.

In embodiments, the curve of the first inner wall ends at a first notch on the first inner wall at a point approximately coplanar with the first nub and the curve of the second inner wall ends at a second notch on the second inner wall at a point approximately coplanar with the second nub. The first and second notch serve to direct the pressure of the first and second inner wall away from top of the squeeze bulb improving the efficiency of the fluid transfer device.

In a condition where the fluid transfer device is empty, the compression of the squeeze bulb forces air out of the fluid transfer device creating a vacuum within the fluid transfer device. While the fluid transfer device may be actuated by manually applying pressure to the first and second actuator members, at the first and second nubs or otherwise, the design of the fluid transfer device in accordance with the present disclosure provides for actuation without a user needing to directly engage with the actuator members, such as by inserting the fluid transfer device into a vial.

After pressure on the first and second actuator members is removed, such as by removing the fluid transfer device from a vial, so long as the pipette tube remains in fluid connection with a sample, the sample will be aspirated into the fluid transfer device. In embodiments, the sample includes a liquid buffer used for a biological testing or analytical process. In embodiments, the fluid transfer device is configured with an overflow channel between the squeeze bulb and pipette tube. By being connected to the squeeze bulb at a location above the bottom of the squeeze bulb, the overflow channel creates an air gap between the pipette tube and the bottom portion of the squeeze bulb. Any liquid over a predetermined amount, determined by the volume of the pipette tube up to the level of the overflow, flows over a lip at the end of the overflow channel at the squeeze bulb and into the bottom reservoir of the squeeze bulb forming an excess liquid reservoir.

Once the sample is in the fluid transfer device, when pressure is next applied on the first and second actuator members, such as by insertion of the fluid transfer device into a vial or a cassette configured to dock into an analytical instrument, the sample is dispensed from the fluid transfer device. In embodiments with an overflow, because there is an air gap between the excess liquid reservoir and the pipette tube, any fluid in the excess liquid reservoir remains in the excess liquid reservoir and is not dispensed.

In embodiments, the fluid transfer device includes a cap covering a portion of the housing, where the cap has a bottom width at least equal to the greatest width of the housing. This prevents the fluid transfer device from being able to be inserted fully into a vial or cassette when used in connection with vials or cassettes which have openings with a diameter greater than at least a lower portion of the housing, but less than bottom width of the cap. In embodiments, where an upper portion of the squeeze bulb is located under the cap, the rigid frame of the cap prevents inadvertently applying force to this upper portion of the squeeze bulb.

In embodiments, the pipette tube of the fluid transfer device includes a sealing rib which improves the fluid transfer device seal with the cassette device to provide an airtight or watertight lock.

In embodiments where a cassette is used in combination with the fluid transfer device and configured to receive a sample from the fluid transfer device, the cassette has an opening on the cassette body with a thickness about equal to the distance between the bottom of the cap of the fluid transfer device and the top surfaces of the first and second nubs of the fluid transfer device. Having a width of this dimension enables the cassette to receive a portion of the housing below the bottom of the cap (including the entirety of the pipette tube) and lock the fluid transfer device therein, between the first and second nubs, functioning as latches and preventing removal of the fluid transfer device from the cassette, and the bottom of the cap of the fluid transfer device.

The fluid transfer device provides for actuating and dispensing of a fixed amount of fluid in response to the external pressure applied to the first and second actuator members. By changing the diameter of the vial or cassette used in conjunction with the fluid transfer system, for example, with a diameter that does not fully compress the first and second actuator members into the squeeze ball, the amount of fluid dispensed can be varied by a known fixed quantity. In embodiments, the volume of liquid aspirated and dispensed is further controlled through the use of an air gap between the pipette tube and the bottom of the squeeze bulb, creating an excess liquid reservoir.

Knowing that there is a fixed amount of fluid that is aspirated and dispensed by the fluid transfer device mitigates overloading and/or underloading a testing device and/or analytic instruments used in connection with the fluid transfer device and the cassette. In embodiments with an air gap between the pipette tube and an excess liquid reservoir at the bottom portion of the squeeze bulb, any additional liquid over the predetermined amount will remain in the excess liquid reservoir after the metered sample is fully dispensed through the pipette tube. In embodiments, the excess liquid reservoir is not part of the squeeze bulb, but remains in fluid connection with the squeeze bulb.

Furthermore, in embodiments, the use of the sealing rib on the pipette tube of the fluid transfer device provides for an air/liquid tight seal within the cassette. This seal ensures that when the cassette is docked into an analytic instrument, in an airtight and/or liquid tight fashion, contamination is prevented.

The following includes definitions of various terms and phrases used throughout this specification.

The terms “about” or “approximately” are defined as being close to as understood by one of ordinary skill in the art. In one non-limiting embodiment the terms are defined to be within 10%, preferably, within 5%, more preferably, within 1%, and most preferably, within 0.5%.

The terms “inhibiting” or “reducing” or “preventing” or “avoiding” or any variation of these terms, when used in the claims and/or the specification, includes any measurable decrease or complete inhibition to achieve a desired result.

The use of the words “a” or “an” when used in conjunction with the term “comprising,” “including,” “containing,” or “having” in the claims or the specification may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The process or the device of the present disclosure can “comprise,” “consist essentially of,” or “consist of” particular ingredients, components, compositions, etc., disclosed throughout the specification. With respect to the transitional phase “consisting essentially of,” in one non-limiting aspect, a basic and novel characteristic of the pressure sensitive adhesives of the present disclosure are their ability to initiate polymer scission in response to a selected electromagnetic radiation.

Other objects, features and advantages of the present disclosure will become apparent from the following figures, detailed description, and examples. It should be understood, however, that the figures, detailed description, and examples, while indicating specific embodiments of the disclosure, are given by way of illustration only and are not meant to be limiting. Additionally, it is contemplated that changes and modifications within the spirit and scope of the disclosure will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF DRAWINGS

Exemplary embodiments of this disclosure will be described with reference to the accompanying figures wherein:

FIG. 1 is a perspective view of a fluid transfer device according to an exemplary embodiment of the present disclosure.

FIG. 2A is a perspective view of an actuating mechanism of the fluid transfer device in its tooled state, according to an exemplary embodiment of the present disclosure.

FIG. 2B is a front view of the actuating mechanism of the fluid transfer device in an assembled state, according to an exemplary embodiment of the present disclosure.

FIG. 2C is a front view of the actuating mechanism of the fluid transfer device in a compressed state, according to an exemplary embodiment of the present disclosure.

FIG. 2D illustrates an alternative construction of the actuating mechanism of the fluid transfer device, shown in its tooled state, according to an exemplary embodiment of the present disclosure.

FIG. 3 is a front view of the fluid transfer device of FIG. 1, shown in a compressed state, when inserted into a vial to aspirate a sample.

FIG. 4A illustrates a front view of an alternative construction of the actuating mechanism of the fluid transfer device, shown in its assembled state, according to an exemplary embodiment of the present disclosure.

FIG. 4B is a front view of the actuating mechanism of the fluid transfer device of FIG. 4A, shown in a compressed state, according to an exemplary embodiment of the present disclosure.

FIG. 5 is a front view of a fluid transfer device using the actuating mechanism of FIGS. 4A and 4B, shown in a compressed state, when inserted into a vial to aspirate a sample.

FIG. 6 is a front view of the fluid transfer device of FIG. 1 shown in a relaxed and aspirated state, after being removed from a vial.

FIG. 7A is a front view of the fluid transfer device using the actuating mechanisms of FIGS. 4A and 4B shown in a relaxed and aspirated state, after being removed from a vial.

FIG. 7B is a cross-sectional view of the fluid transfer device taken along the lines 7B-7B in FIG. 7A in the direction shown by the arrows.

FIG. 8 is a front view of the fluid transfer device of FIG. 1, shown engaged with a receiving device after having dispensed a sample.

### DETAILED DESCRIPTION

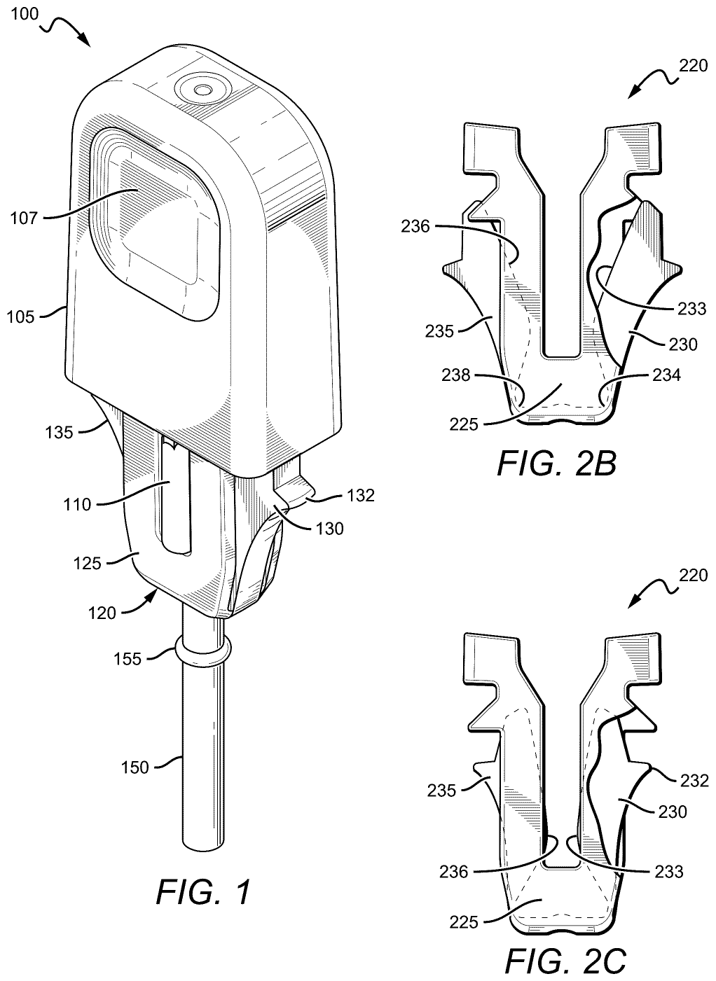

Initially referring to FIG. 1 for the structure of the present disclosure, an embodiment of transfer device 100 described herein includes cover 105, squeeze bulb 110, actuating mechanism 120 and pipette tube 150. Actuating mechanism 120 is comprised of housing 125, first actuator member 130 and second actuator member 135. The first and second actuator members are shown in FIG. 1 in a relaxed state.

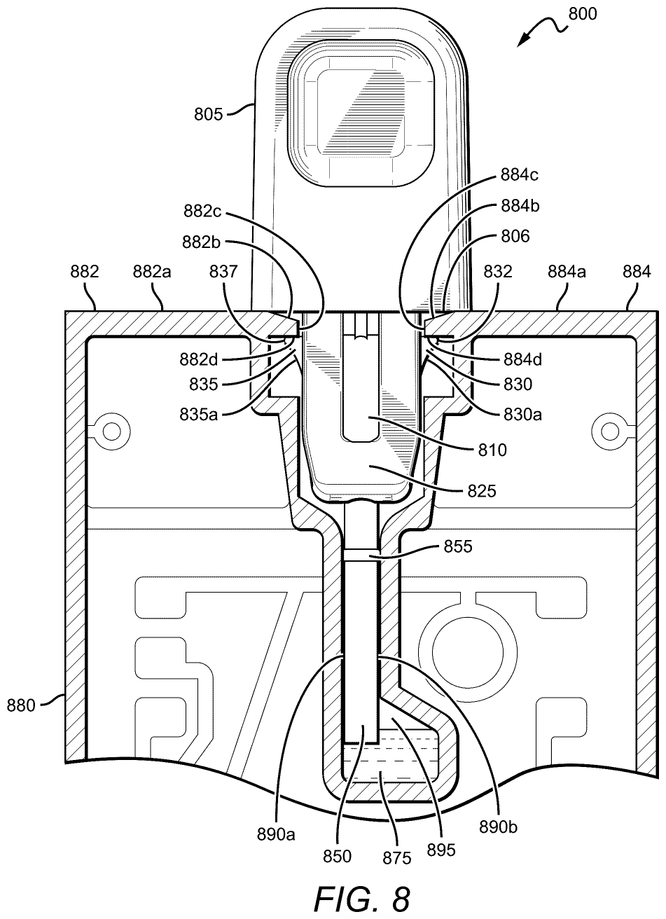

First actuator member 130 has a first nub 132 which functions both as an actuator and as a latch. Second actuator member 135 has a corresponding second nub (not shown). Squeeze bulb 110 is shown located within housing 125 of actuating mechanism 120 and between first actuator member 130 and second actuator member 135. Squeeze bulb 110 is coupled to pipette tube 150. In embodiments, squeeze bulb 110 is coupled to an upper squeeze bulb, located under cover 105, which can serve to assist in keeping the pipette in place within the fluid transfer device. In embodiments, pipette tube 150 includes sealing rib 155, which is designed to improve the fluid transfer device seal with the cassette device as shown in FIG. 8.

In embodiments, squeeze bulb 110 can be made from any flexible material that retains structural shape without the application of pressure. In embodiments, squeeze bulb 110 is an elliptical shape to provide a slower controlled operation of the fluid transfer device. An exemplary material for fabrication of squeeze bulb 110 includes plastic, such as polypropylene or the like. In embodiments, pipette tube 150 and squeeze bulb 110 are formed in a unibody configuration. In alternate embodiments, pipette tube 150 and squeeze bulb 110 are assembled from separate pieces.

In embodiments, cover 105 is constructed of a rigid material to prevent inadvertently applying force to the portion of the squeeze bulb located within the housing and under cover 105. In embodiments where an upper squeeze bulb is located under cover 105, the upper squeeze bulb serves to stabilize the squeeze bulb within the housing. In embodiments, cover 105 includes one or more indents on the cover outer surface to be used as a finger recess, as shown by indent 107. The one or more finger recesses facilitate holding the pipette cover with the user's fingers. Cover 105 can be constructed of any rigid material including wood, metal or plastic. In embodiments, injection molding is used to fabricate cover 105. In embodiments, sealing rib 155 is fabricated from a deformable material such that it can compress to form a seal when coming in contact with a more durable surface.

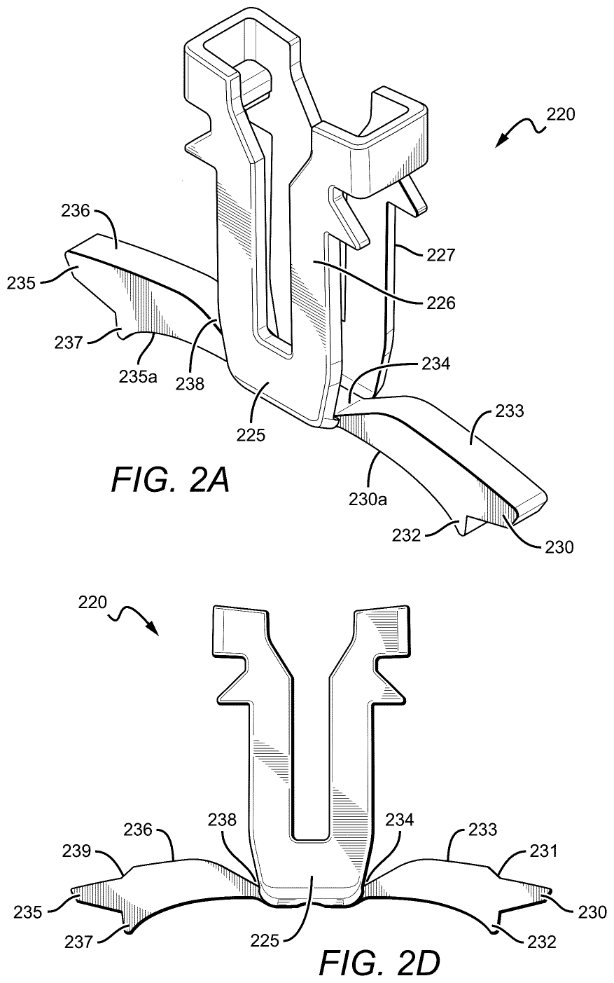

FIGS. 2A through 2D provide further detail into the structure and operation of the actuating mechanism. Referring initially to FIG. 2A, actuating mechanism 220 is illustrated in its tooled state, with first actuator member 230 connected to housing 225 at first actuator hinge 234 located at a first end and second actuator member 235 connected to housing 225 at second actuator hinge 238 located at a second end. The second actuator hinge is obscured in FIG. 2A by the perspective view, but can be seen in other views, such as the alternative embodiment illustrated in FIG. 2D. In the embodiment shown in FIG. 2A, first actuator hinge 234 and second actuator hinge 238 are pivot points for a single piece of injection molded plastic. In embodiments, the first and second actuator hinges are located at the lower portion of the housing. In the embodiment shown in FIG. 2A, the first and second actuator hinges are located at the bottom portion of the housing (i.e., the bottom portion of the lower portion of the housing). In embodiments, the first actuator member and second actuator member may be separate structures joined to the housing using a hinge constructed of plastic, metal or any other suitable material.

First actuator member 230 has a curved first inner wall 233, curved convexly, facing the center of housing 225 and a curved outer wall 230a, curved concavely, facing away from the center of housing 225, as shown in FIG. 2A. Second actuator member 235 has a curved second inner wall 236, curved convexly, facing the center of housing 225 and a curved outer wall 235a, curved concavely, facing away from the center of housing 225, as shown in FIG. 2A. Housing 225 is configured for engagement of first actuator member 230 and second actuator member 235 by sliding insertion in opposing directions, both towards the center of housing 225, between first housing wall 226 and second housing wall 227 and pivoting into the housing at first actuator hinge 234 and second actuator hinge 238. First nub 232 is shown on first actuator member 230 and second nub 237 is shown on second actuator member 235.

Turning to FIG. 2B, the assembled state (i.e., relaxed state) of actuating mechanism 220 is shown. In the assembled state, first actuator member 230 and second actuator member 235 are each slidably engaged with housing 225, pivoting along first actuator hinge 234 and second actuator hinge 238, with first inner wall 233 facing second inner wall 236. The cut-away view of FIG. 2B illustrates the slidable engagement of the first and second actuator members with housing 225.

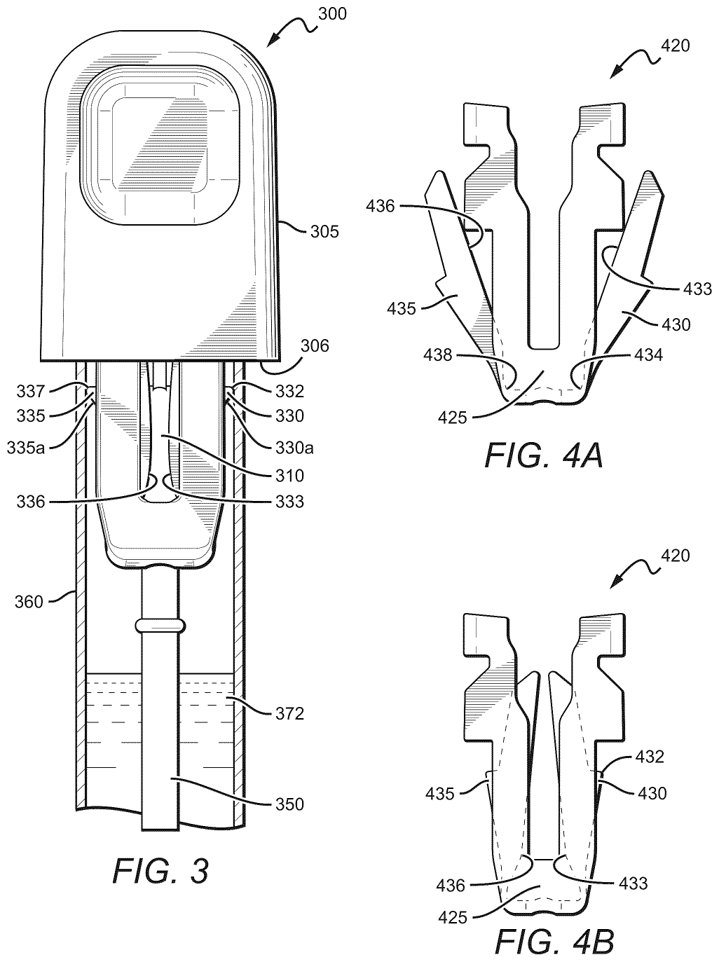

Turning to FIG. 2C, the fully compressed state of actuating mechanism 220 is shown. In the fully compressed state, first actuator member 230 and second actuator member 235 are slidably engaged with housing 225 (as further illustrated by use of the cut-away view of FIG. 2C), with less distance between first inner wall 233 and second inner wall 236 than when actuating mechanism 220 is in the assembled (i.e., relaxed) state, as shown in FIG. 2B. As seen in FIG. 2C, the first inner wall 233 and second inner wall 236 have started to enter the space within the housing where the squeeze bulb would be located when the fluid transfer device is fully assembled. In this configuration, the squeeze bulb, were it contained within the housing, would begin to be compressed. The fully actuated state of the fluid transfer device, with the squeeze bulb fully compressed, is shown in FIG. 3.

Turning to FIG. 2D, an alternate embodiment of actuator mechanism 220 is shown in its tooled state. In this embodiment, the curve of first inner wall 233 on first actuator member 230 ends at a first notch 231 on first inner wall 233 at a point approximately coplanar with first nub 232 and the curve of second inner wall 236 on second actuator member 235 ends at a second notch 239 on second inner wall 236 at a point approximately coplanar with second nub 237. The first and second notch serve to direct the pressure of the first and second inner wall away from top of the squeeze bulb improving the efficiency of the fluid transfer device. In an alternative embodiment (not shown), the slope of the first and second inner walls, from the first and second actuator hinges and leading up to the portion of the first and inner walls that makes contact with the squeeze bulb is even more pronounced, such that greater portions of the first and second inner walls come in contact with the squeeze bulb when in the fully actuated state. In this alternative embodiment, the portions of the first and second inner walls that come into contact with the squeeze bulb is generally flat (i.e., not curved) such that the portions of the first and second inner walls that come in contact with the squeeze bulb align in a longitudinal direction generally parallel to the squeeze bulb when in a fully actuated state. In this configuration, the generally flat portions of the first and second inner walls end at the first and second notch.

FIG. 3 illustrates transfer device 300 in a fully actuated state when actuated through the use of a vial. In FIG. 3, transfer device 300 is actuated by insertion of transfer device 300 into vial 360 containing fluid 372. As transfer device 300 is inserted into vial 360, the inner wall of vial 360 actuates transfer device 300 by applying pressure to first actuator member 330 and second actuator member 335, first along the first outer wall 330a of first actuator member 330 and second outer wall 335a of second outer wall 335, ultimately applying pressure on the first and second actuator members at the edge of the first nub 332 and the edge of second nub 337. In embodiments, cover 305 is designed with a width of bottom edge 306 greater than the diameter of vial 360, which prevents transfer device 300 from entering vial 360 past bottom edge 306 of cover 305. In order to function properly, the end of pipette tube 350 must be in connection with fluid 372 when the fluid transfer device is inserted to its maximum depth into vial 360 and when the first and second actuator members reach their relaxed state when being withdrawn from the vial as shown in FIG. 6.

The pressure on the first and second actuator members, applied by the inner wall of vial 360 as transfer device 300 is inserted into vial 360 brings the actuating mechanism into a compressed state, compressing squeeze bulb 310 between the first inner wall 333 and the second inner wall 336 of the first and second actuator members. When squeeze bulb 310 is compressed, air within squeeze bulb 310 is expelled through pipette tube 350 creating a vacuum within transfer device 300. While transfer device 300 may be actuated by manually applying pressure to first actuator member 330 and second actuator member 335, through the use of fingers, by example, the design of the fluid transfer device in accordance with the present disclosure provides for actuation without a user needing to directly touch the actuator members, such as by inserting the fluid transfer device into a vial as illustrated in FIG. 3.

In embodiments, as shown in FIG. 3, vial 360 is cylindrical. However, transfer device 300 can work in combination with a vial of any dimensions such that the first and second actuator members come in contact with the inner walls of the vial when the fluid transfer device is inserted into the vial.

Turning to FIG. 4A, an alternate embodiment of the actuator mechanism, namely actuating mechanism 420, is shown in the assembled state (i.e., relaxed state). In the assembled state, first actuator member 430 and second actuator member 435 are each slidably engaged with housing 425, pivoting along first actuator hinge 434 and second actuator hinge 438, with first inner wall 433 facing second inner wall 436.

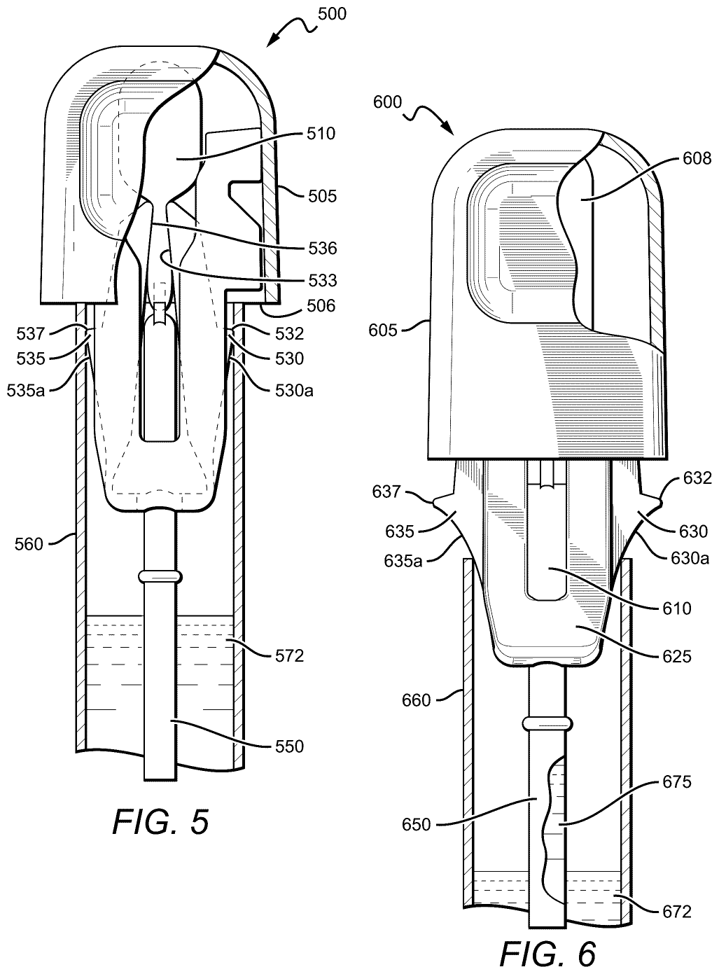

Turning to FIG. 4B, the fully compressed state of actuating mechanism 420 is shown. In the fully compressed state, first actuator member 430 and second actuator member 435 are slidably engaged with housing 425, with less distance between first inner wall 433 and second inner wall 436 than when actuating mechanism 420 is in the assembled (i.e., relaxed) state, as shown in FIG. 4A. As seen in FIG. 4B, the first inner wall 433 and second inner wall 436 have started to enter the space within the housing where the squeeze bulb would be located when the fluid transfer device is fully assembled. In this configuration, the squeeze bulb, were it contained within the housing, would begin to be compressed. The fully actuated state of the fluid transfer device in accordance with this embodiment, with the squeeze bulb fully compressed, is shown in FIG. 5.

FIG. 5 illustrates an alternate embodiment of the fluid transfer device, namely transfer device 500, using the actuating mechanism shown in FIGS. 4A and 4B, in a fully actuated state when actuated through the use of a vial. In FIG. 5, transfer device 500 is actuated by insertion of transfer device 500 into vial 560 containing fluid 572. As transfer device 500 is inserted into vial 560, the inner wall of vial 560 actuates transfer device 500 by applying pressure to first actuator member 530 and second actuator member 535, first along the first outer wall 530a of first actuator member 530 and second outer wall 535a of second outer wall 535, ultimately applying pressure on the first and second actuator members at the edge of the first nub 532 and the edge of second nub 537. In embodiments, cover 505 is designed with a width of bottom edge 506 greater than the diameter of vial 560, which prevents transfer device 500 from entering vial 560 past bottom edge 506 of cover 505. In order to function properly, the end of pipette tube 550 must be in connection with fluid 572 when the fluid transfer device is inserted to its maximum depth into vial 560 and when the first and second actuator members reach their relaxed state when being withdrawn from the vial.

The pressure on the first and second actuator members, applied by the inner wall of vial 560 as transfer device 500 is inserted into vial 560 brings the actuating mechanism into a compressed state, compressing squeeze bulb 510 between the first inner wall 533 and the second inner wall 536 of the first and second actuator members. When squeeze bulb 510 is compressed, air within squeeze bulb 510 is expelled through pipette tube 550. While transfer device 500 may be actuated by manually applying pressure to first actuator member 530 and second actuator member 535, through the use of fingers, for example, the design of the fluid transfer device in accordance with the present disclosure provides for actuation without a user needing to directly touch the actuator members, such as by inserting the fluid transfer device into a vial as illustrated in FIG. 5.

Turning to FIG. 6, transfer device 600 is shown as it is removed from vial 660. When removed from vial 660, as pressure is removed from first actuator member 630 and second actuator member 635, the actuator members return to the relaxed state as the inner wall of vial 660 no longer presses against first nub 632 of first actuator member 630 and second nub 637 of second actuator member 635 and then first outer wall 630a and second outer wall 635a of the first and second actuator members.

As the first and second actuator members return to their relaxed state, the inner walls of the first and second actuator members (not shown as they are now located within housing 625) no longer apply pressure to squeeze bulb 610, which then expands. As squeeze bulb 610 expands, a suction force is generated within transfer device 600. With pipette tube 650 in connection with fluid 672, fluid enters pipette tube 650, becoming sample 675, seen in the cut-away view on FIG. 6, and completing the aspiration process. In the embodiment shown in FIG. 6, a second cut-away view shows upper squeeze ball 608, positioned within the upper portion of the housing and under cap 605.

In the embodiment shown in FIG. 6, outer wall 630a of first actuator member 630 and outer wall 635a of second actuator member 635 are concavely curved. In embodiments (not shown) the outer walls of the first and second actuator members are flat (i.e., not curved). By adjusting the diameter of vial 660, the volume of fluid aspirated can be varied. For example, while the maximum fluid volume of is aspirated when the first and second actuator members are compressed to their maximum state, such as shown in FIG. 3, in an embodiment where the vial is of a greater diameter than that shown in FIG. 3, a sample size of lesser volume will be aspirated when the fluid transfer device is removed from the vial.

In the embodiment shown in FIG. 6, vial 660 is cylindrical. However, the vial used may be of any configuration so long as the walls of the vial engage the first and second actuator members to aspirate the sample.

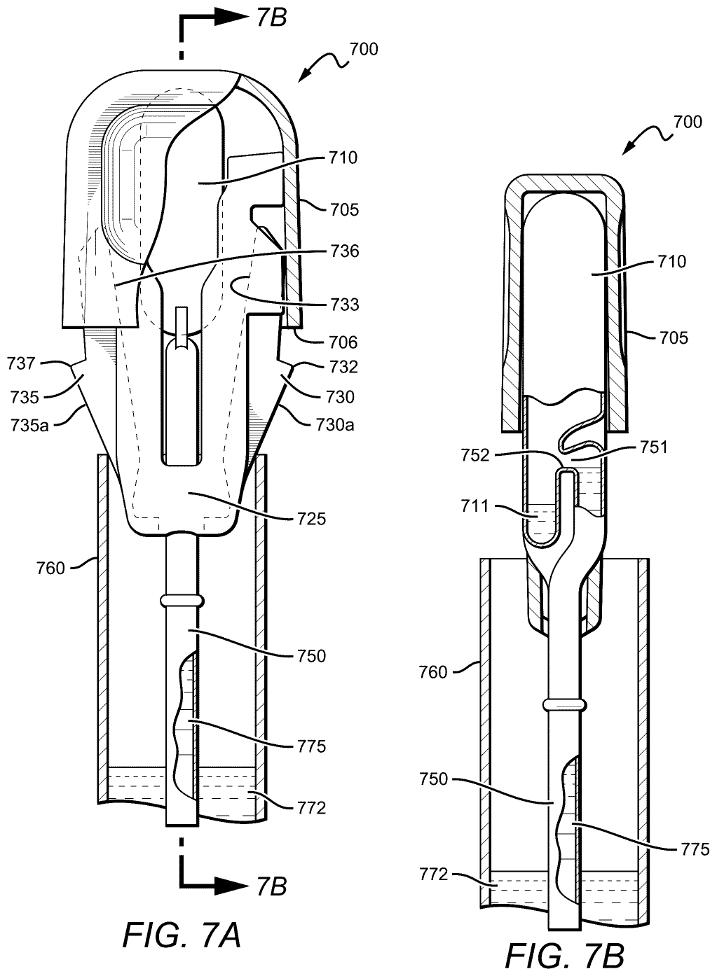

An alternate embodiment of the fluid transfer device, with an overflow, is shown in FIGS. 7A and 7B. Turning to FIG. 7A, transfer device 700 is shown as it is removed from vial 760. When removed from vial 760, as pressure is removed from first actuator member 730 and second actuator member 735, the actuator members return to the relaxed state as the inner wall of vial 760 no longer presses against first nub 732 of first actuator member 730 and second nub 737 of second actuator member 735 and then first outer wall 730a and second outer wall 735a of the first and second actuator members.

As the first and second actuator members return to their relaxed state, the inner walls of the first and second actuator members (shown in broken line as they are now located within housing 725) no longer apply pressure to squeeze bulb 710, which then expands. As squeeze bulb 710 expands, a suction force is generated within transfer device 700. With pipette tube 750 in connection with fluid 772, fluid enters pipette tube 750, becoming sample 775, seen in the cut-away view on FIG. 7A, and completing the aspiration process.

The fluid transfer device shown in FIG. 7A is equipped with an overflow. FIG. 7B is a cross-sectional view along the line 7B-7B shown in FIG. 7A and shows the overflow in detail. As shown in FIG. 7B, pipette tube 750 is coupled to squeeze bulb 710 through overflow channel 751 at a location above excess liquid reservoir 711. In the embodiment shown in FIG. 7B, excess liquid reservoir 711 is the bottom of squeeze bulb 710. However, in embodiments (not shown) the excess liquid reservoir need not be part of the squeeze bulb so long as it remains in fluid connection with the squeeze bulb, and excess liquid can flow by gravity from the overflow channel into the excess liquid reservoir.

In the embodiment shown in FIG. 7B, overflow channel 751 is shown as a horizontal connection between pipette tube 750 and squeeze bulb 710, but overflow channel 751 can be of any configuration such that the fluid does not rise above lip 752 of overflow channel 751. As seen in FIG. 7B, when excess liquid is aspirated by the fluid transfer device, any liquid volume that exceeds the targeted amount (as defined by the volume of the pipette tube up to the height of lip 752, 80 microliters in one embodiment) pours from overflow channel 751 over lip 752 and into excess liquid reservoir 711 of squeeze bulb 710. Since there is an air gap between the fluid in excess liquid reservoir 711 and the fluid in pipette tube 750, when squeeze bulb 710 is compressed, causing fluid to be dispensed through pipette tube 750, the fluid in excess liquid reservoir 711 will remain in the reservoir and not be dispensed. As seen in FIG. 7B, the portion of pipette tube 750 housed within the actuating mechanism is configured in a manner such that the first and second actuating members do not engage the pipette tube when pressure is applied on them.

As with aspiration of the sample, dispensing of the sample can be accomplished either by physically pressing on the first and second actuator members such as with a user's fingers, or, by inserting the fluid transfer device into a receiving device such as a cassette with an opening of a fixed width that, in embodiments, is only slightly wider than the housing to accommodate a snug fit. One such embodiment is shown in FIG. 8, where transfer device 800 is shown inserted into cassette 880. Transfer device 800 can be securely locked into cassette 880 in an airtight and/or liquid tight fashion, through the use of sealing rib 855, to prevent sample contamination and/or any sample being released from the cassette. In embodiments, cassette 880 can be configured to control the amount of sample released from the pipette, based upon the width of the opening, improving sample control in the cassette and the accuracy of the testing conducted by an analytical instrument used in combination with the cassette.

Cassette 880 is designed with an opening for transfer device 800. In the embodiment shown in FIG. 8, cassette 880 has outer walls 882 and 884 on the same plane with the opening located between them in the space shown between outer wall portions 882c and 884c. In embodiments, a portion of outer walls 882 and 884, namely portions 882b and 884b, located adjacent to the opening, are angled inward towards the interior of the cassette, to aid in the dispensing of sample 875 as transfer device 800 is inserted into cassette 880. In embodiments, the opening lacks these angled portions.

As transfer device 800 is inserted into cassette 880, first actuator member 830 and second actuator member 835 are compressed along first outer wall 830a and second outer wall of 835a, and ultimately against first nub 832 of first actuator member 830 and second nub 837 of second actuator member 835 causing the first inner wall of the first actuator member and second inner wall of the second actuator member to compress squeeze bulb 810. When squeezed by the first and second inner walls, pressure increases within squeeze bulb 810, dispensing sample 875 through pipette tube 850 into cavity 895. In FIG. 8, sample 875 is shown after it has been dispensed into cavity 895. In embodiments with an overflow, any excess liquid above the desired volumetric amount would remain within the excess liquid reservoir of the squeeze bulb (not shown). Sealing rib 855 provides a seal between first sealing wall 890a and second sealing wall 890b of cassette 880. As shown in FIG. 8, the opening between first sealing wall 890a and second sealing wall 890b is of a width less than the outer diameter of sealing rib 855, thus creating a seal when sealing rib 855 enters the opening between first sealing wall 890a and second sealing wall 890b and compresses to form a seal. This sealing provides prevent the escape of gas or liquid from the cassette including when used with an assay machine. In embodiments, first sealing wall 890a and second sealing wall 890b are instead the outer perimeter of a sealing tube which is configured to receive pipette tube 850 and with an inner diameter less than the outer diameter of sealing rib 855 such that the sealing rib provides a seal preventing the escape of gas or liquid from cassette 880.

By angling portions 882b and 884b of outer walls 882 and 884 of cassette 880, in embodiments, pressure is more gently applied to first actuator member 830 and second actuator member 835 when transfer device 800 is inserted into cassette 880. Cover 805 is designed with a width wider than the cassette opening to prevent transfer device 800 from being inserted deeper into cassette 880 than bottom surface 806 of cover 805.

In embodiments, the opening of cassette 880 for receiving transfer device 800 is designed to be the maximum width of the actuator mechanism when in the fully compressed state. As such, after first actuator member 830 and second actuator member 835 pass through the opening, the first and second actuator member return to their relaxed state, as shown in FIG. 8, causing transfer device 800 to be locked in place in the cassette, with first nub 832 and second nub 837 acting as latches in communication with surfaces 882d and 884d of the outer wall of cassette 880, to prevent transfer device 800 from being removed from cassette 880 and bottom surface 806 of cover 805 preventing transfer device 800 from being inserted any further into cassette 880. In embodiments, at least portions of cassette walls 882 and 884, in particular the portion closest to the cassette opening, are designed with a thickness equal to the distance between bottom 806 of cover 805 and the top surfaces of first nub 832 and second nub 837. This results in a snug fit when transfer device 800 is inserted and locked into place in connection with cassette 880.

In embodiments, the content of cassette 880 can include an infectious pathogen or a biological material from an infectious pathogen. The biological material can include nucleic acid. The infectious pathogen can include virus and/or bacteria. Exemplary pathogens can include SARS-CoV-2 virus, Flu A/Flu B virus, and respiratory syncytial virus (RSV).

In embodiments, cassette 880 can include a reaction chamber configured to conduct reaction(s) that facilitates a biological testing and/or biological analytical process. In embodiments, the reaction chamber is configured to host a polymerase chain reaction (PCR). The polymerase chain reaction can include a quantitative polymerase chain reaction. In embodiments, the cassette can include a metering mechanism. In embodiments, the metering mechanism includes an overflow chamber, configured to receive excessive content from the reaction chamber, when the sample is released from the pipette.

Although embodiments of the present application and their advantages have been described in detail, it should be understood that various changes, substitutions and alterations can be made herein without departing from the spirit and scope of the embodiments as defined by the appended claims. Moreover, the scope of the present application is not intended to be limited to the particular embodiments of the process, machine, manufacture, composition of matter, means, methods, and/or steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed:

1. A fluid transfer device comprising:
an actuating mechanism, the actuating mechanism comprising:
a first actuator member connected to a lower portion of a housing at a first actuator hinge;
a second actuator member connected to the lower portion of the housing at a second actuator hinge, the first actuator hinge being located at an opposing end of the housing from the second actuator hinge;
a squeeze bulb located within the housing; and
a pipette tube coupled to the squeeze bulb;
wherein the first actuator member and the second actuator member are configured to compress the squeeze bulb by pivoting into the housing at the first actuator hinge and the second actuator hinge.

2. The fluid transfer device of claim 1 wherein the first actuator hinge and the second actuator hinge are located at the bottom of the housing.

3. The fluid transfer device of claim 1, wherein the housing, the first actuator member, the first actuator hinge, the second actuator member and the second actuator hinge are comprised of a single piece of material.

4. The fluid transfer device of claim 3 wherein the single piece of material is injected molded plastic.

5. The fluid transfer device of claim 1, wherein the squeeze bulb is constructed of polypropylene.

6. The fluid transfer device of claim 1, wherein the squeeze bulb and the pipette tube are formed in a unibody configuration.

7. The fluid transfer device of claim 1, wherein the squeeze bulb is elliptical in shape.

8. The fluid transfer device of claim 1, wherein the pipette tube is coupled to the squeeze bulb through an overflow channel; and the overflow channel is coupled to the squeeze bulb at a location above an excess liquid reservoir.

9. The fluid transfer device of claim 1, further comprising:
a cap covering a portion of the housing, wherein the cap has a bottom width at least equal to the greatest width of the housing.

10. The fluid transfer device of claim 9, wherein the squeeze bulb is coupled to an upper squeeze bulb located under the cap.

11. The fluid transfer device of claim 10, wherein the squeeze bulb, upper squeeze bulb and pipette tube are formed in a unibody configuration.

12. The fluid transfer device of claim 9, wherein the cap is constructed of a rigid plastic material.

13. The fluid transfer device of claim 9, further comprising a sealing rib located on the pipette tube.

14. The fluid transfer device of claim 13, wherein:
the first actuator member has a first inner wall facing the housing and a first outer wall facing away from the housing;
the second actuator member has a second inner wall facing the housing and a second outer wall facing away from the housing; and
the first inner wall and second inner wall each comprise a convex curve.

15. The fluid transfer device of claim 14, wherein:
the first outer wall and the second outer wall each comprise a concave curve, and the concave curve of the first outer wall and the concave curve of the second outer wall each terminate at a vertex forming a first nub on the first outer wall and a second nub on the second outer wall, the first nub and the second nub configured to function as a latch when the fluid transfer device is used in combination with a cassette.

16. The fluid transfer device of claim 15, wherein:
the convex curve of the first inner wall ends at a first notch on the first inner wall at a point approximately coplanar with the first nub; and
the convex curve of the second inner wall ends at a second notch on the second inner wall at a point approximately coplanar with the second nub.

17. A fluid transfer device comprising:
an actuating mechanism, the actuating mechanism comprising: a housing,
a first actuator member connected to the bottom of the housing at a first actuator hinge, the first actuator member having a first inner wall facing the housing and a first outer wall facing away from the housing, the first inner wall comprising a convex curve;
a second actuator member connected to the bottom of the housing at a second actuator hinge, the second actuator member having a second inner wall facing the housing and a second outer wall facing away from the housing, the second inner wall comprising a convex curve;
the first outer wall and the second outer wall each comprise a concave curve, and the concave curve of the first outer wall and the concave curve of the second outer wall each terminate at a vertex forming a first nub on the first outer wall and a second nub on the second outer wall, the first nub and the second nub configured to function as a latch when the fluid transfer device is used in combination with a cassette;
a squeeze bulb of an elliptical shape located within the housing;
a pipette tube coupled to the squeeze bulb through an overflow channel, the overflow channel coupled to the squeeze bulb at a location above an excess liquid reservoir;
a sealing rib located on the pipette tube; and
a cap covering a portion of the housing, wherein the cap has a bottom width at least equal to the greatest width of the housing;
wherein the first actuator member and the second actuator member are configured to compress the squeeze bulb by pivoting into the housing at the first actuator hinge and the second actuator hinge.

18. A system comprising:
the fluid transfer device of claim 1;
a cassette configured to receive a sample from the fluid transfer device, the cassette comprising:
a cassette body with an outer wall; and
an opening along the outer wall,
wherein portions of the outer wall closest to the opening have a thickness about equal to the distance between the bottom of the cap of the fluid transfer device and the first and second nubs of the fluid transfer device, the opening configured to receive a portion of the housing below the bottom of the cap and lock the fluid transfer device therein.

19. The system of claim 18, wherein:
the portions of the outer wall closest to the opening are angled inwards toward the interior of the cassette.

20. The system of claim 18, wherein the cassette is further configured with a first sealing wall and a second sealing wall configured to receive the pipette tube and spaced apart a distance less than the outer diameter of the sealing rib.

21. The system of claim 20, wherein the first sealing wall and second sealing wall comprise a portion of the perimeter of a sealing tube with a diameter less than the outer diameter of the sealing rib.
